(19) United States
(12) Patent Application Publication
(10) Pub. No.: US 2025/0270929 A1
(43) Pub. Date: Aug. 28, 2025

(54) EXPANSION ANCHOR SYSTEM HAVING IMPROVED BULLET THEREFOR

(71) Applicant: Robert COUSINEAU, Ottawa (CA)

(72) Inventor: Robert COUSINEAU, Ottawa (CA)

(21) Appl. No.: 19/061,219

(22) Filed: Feb. 24, 2025

Related U.S. Application Data
(60) Provisional application No. 63/556,929, filed on Feb. 23, 2024.

(51) Int. Cl. E21D 21/00; F16B 13/06

(52) U.S. Cl. CPC E21D 21/0053; F16B 13/063

(57) ABSTRACT

The present disclosure provides a system to optimally set an anchor and a bullet within a pre-drilled bore hole. The anchor is comprised of at least two spreading lamellae, the spreading lamellae having a cutter to cut through cementitious material in the bore hole. The cutter comprises a tapered face to minimize contact with a bullet. In turn, the bullet is comprised of a radial flange to act as a stop for the spreading lamellae so that the anchor does not over drill deeper in the pre-drilled bore hole.

### CROSS REFERENCE TO RELATED APPLICATION

The present application claims priority to U.S. Provisional Application No. 63/556,929 entitled “EXPANSION ANCHOR SYSTEM HAVING IMPROVED BULLET THEREFOR” filed on Feb. 23, 2024, and incorporated herein by reference in its entirety.

### FIELD

The invention relates to the field of anchors, and more specifically to an expansion anchor system having an improved bullet to prevent overexpansion of the anchor into the bore hole.

### BACKGROUND

Self-undercut anchor systems are generally comprised of an anchor to set over a bullet in a bore hole. During typical installation, the spreading lamellae of the anchor will spread out radially over the bullet and into the cementitious material of the bore hole. Inventions have been disclosed to facilitate the spreading of such lamellae, including utilizing a carbide bit or cutter onto the spreading lamellae to dig into a pre-drilled the bore hole to set the anchor.

Unfortunately, the spreading lamellae in anchor systems of the prior art will spread uncontrollably deeper and thus too far into the desired preset depth in the pre-drilled bore hole. As such, there is a need for a new bullet design to create a stop point and prevent the lamellae from spreading further and overdrilling, while providing additional space for cement dust to during setting of the anchor.

There is also a need to provide reduced contact between the anchor and the bullet when the bullet is further connected to the anchor.

### SUMMARY

In an embodiment, the present disclosure provides an expansion anchor system for use in a pre-drilled bore hole, the system comprising: an anchor comprised of at least two spreading lamellae to expand in the borehole; and, a bullet to provide a surface on which the at least two spreading lamellae can spread to set the anchor, the bullet comprising a radial flange, wherein the spreading of the at least two spreading lamellae is stopped by the radial flange.

In another embodiment, the present disclosure provides a bullet for use with an anchor to set in a pre-drilled bore hole, the bullet comprising: a neck adapted to be positioned in the anchor; and, a body extending from the neck, the body expanding radially and terminating in a radial flange, wherein the radial flange has a first diameter that is greater than a second diameter of the body, the radial flange to provide a stop point for the anchor when the anchor is set.

### BRIEF DESCRIPTION OF THE DRAWINGS

The following figures serve to illustrate various embodiments of features of the disclosure. These figures are illustrative and are not intended to be limiting.

FIG. 1 is a front view of a setting tool, an anchor, and a bullet, according to an embodiment of the present disclosure;

FIG. 2 is a front view of the setting tool, the anchor, and the bullet within a cross-sectional view of a pre-drilled bore hole, according to an embodiment of the present disclosure;

FIG. 3 is a front view of the setting tool, the anchor in an expanded state, and the bullet within a cross-sectional view of the pre-drilled bore hole, according to an embodiment of the present disclosure;

FIG. 4 is an exploded perspective view of the setting tool, the anchor, and the bullet, according to an embodiment of the present disclosure;

FIG. 5 is an enlarged exploded perspective of the setting tool, the anchor, the bullet and the carbide cutter, according to an embodiment of the present disclosure;

FIG. 6 is a perspective view of the anchor of FIG. 1, according to an embodiment of the present disclosure; and,

FIG. 7 is a perspective view of the bullet of FIG. 1, according to an embodiment of the present disclosure.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

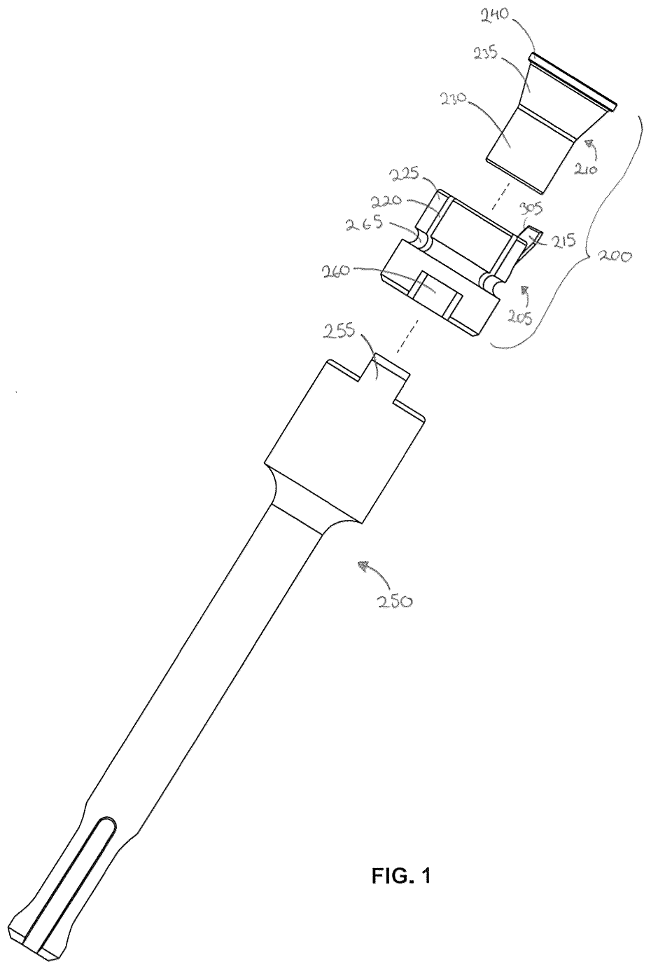

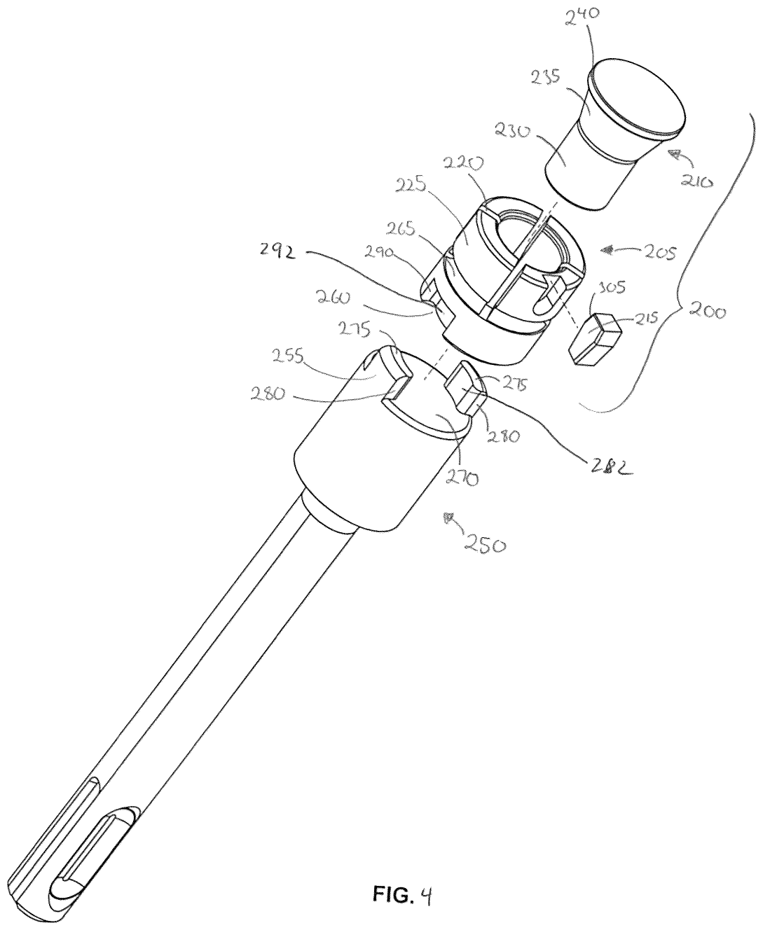

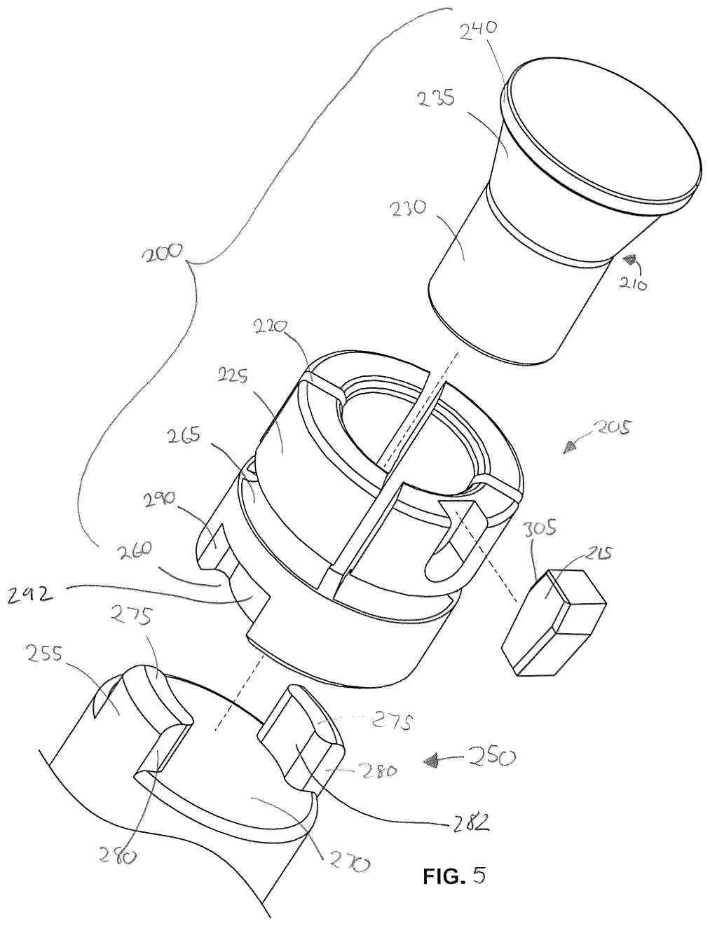

With reference to FIGS. 1, 4, and 5, and according to an embodiment of the present disclosure, an expansion anchor system 200 is shown, preferably comprising an anchor 205 and a bullet 210. The anchor 205 is further comprised of at least one angular cutter 215. Although this preferred embodiment describes one cutter 215, a worker skilled in the art would understand that any number of cutters 215 are possible. A worker skilled in the art would appreciate that the cutter 215 is made of brazed tungsten carbide, although other materials may be used. The anchor 205 is also comprised of at least two, and preferably four, slits 220 positioned at the upper end of the anchor 205, each one of the slits 220 separated by a spreading lamella 225. As shown specifically in FIGS. 4 and 5, and according to an embodiment of the present disclosure, the four slits 220 are positioned equidistantly from one another on the anchor 205. The slits 220 run down the length of the anchor 205, from the upper end of the anchor 205 until approximately halfway down the anchor 205. A worker skilled in the art would appreciate that the slits 220 allow for the spreading lamellae 225 of the anchor 205 to spread radially over the bullet 210 during setting of the anchor 205. In another embodiment of the anchor 205, at least one, and preferably four, grooves 265 may each be positioned in the area where each of the spreading lamellae 225 terminate halfway down the anchor 205. Such grooves 265 may facilitate the radial spreading of the lamellae 225 over a body 235 of the bullet 210. A bullet 210 is shown, preferably bell-shaped and further comprising a neck 230 and a trapezoid-shaped body 235 terminating in a flange 240. The neck 230 of the bullet 210 can be positioned within the upper end of the anchor 205. During the setting of the anchor 205, the upper end of the anchor 205 spreads radially over the body 235 of the bullet 210 to secure the anchor 205 and the bullet 210 within a pre-drilled bore hole 245 (not shown). The radial flange 240 positioned at an upper end of the bullet 210 serves to create a stopping point and to stop the upward and radial expansion of the lamellae 225 over the bullet 210. Indeed, it has been shown that without the radial flange 240, the lamellae 225 and the cutter 215 would spread too far and potentially over exceeding the setting depth of the anchor 205. Additionally, the anchor 205 would uncontrollably continue to bore further into the bore hole 245. A setting tool 250 is shown, comprising at least one, but preferably two, teeth 255 protruding from an upper end of the setting tool 250. The teeth 255 are adapted to fit within at least one, but preferably two, anchor recesses 260. A worker skilled in the art would appreciate that the teeth 255 allow the setting tool 250 to be connected to the anchor 205. Additionally, when the teeth 255 are positioned within the anchor recesses 260, any rotational movement of the setting tool 250 will be transferred to the anchor 205, thereby allowing the cutter 215 to move circumferentially to shave and scrape the material in the pre-drilled bore hole 245 (not shown).

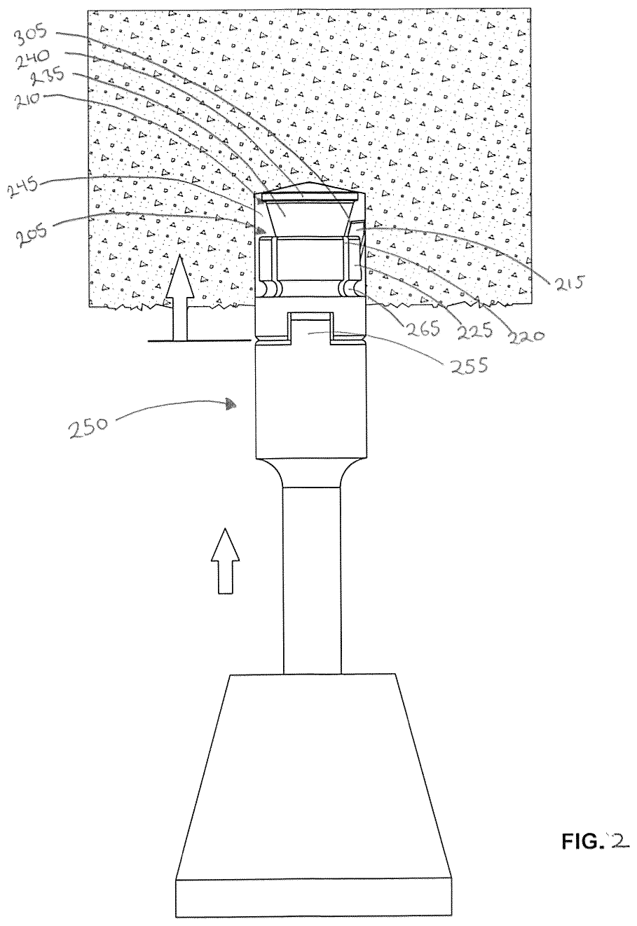

With reference to FIG. 2 and according to an embodiment of the present disclosure, the bullet 210 and anchor 205 are shown inserted within the pre-drilled bore hole 245. The neck (not shown) of the bullet 210 is positioned within the spreading lamellae 225 of the anchor 205. The radial flange 240 is configured to fit into the pre-drilled bore hole 245 and provide a controlled stop for the anchor 205 when the anchor 205 is positioned over the bullet 210 before the anchor 205 is set. It is known in the art that with traditional bell-shaped bullets, dust accumulates in the bore hole and does not permit proper setting of the anchor, as dust takes up space within the bore hole. The present slits 220 between lamellae 225 of the anchor 205 provide sufficient spacing for any dust resulting from the minimal scraping of the cutter 215 to flow outwardly of the bore hole 245. Having the slits 220 therefore increases area for dust to flow during setting.

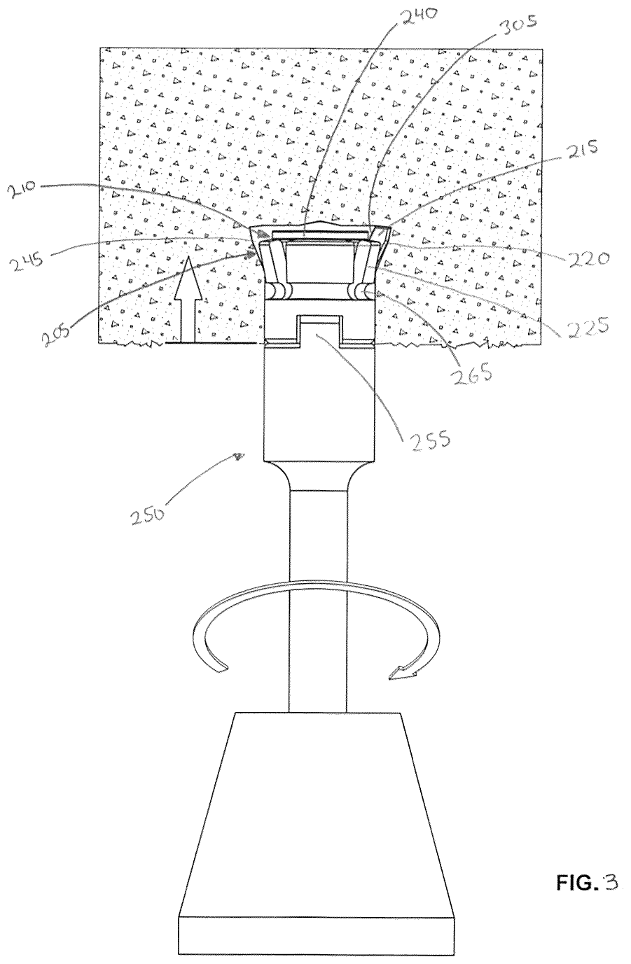

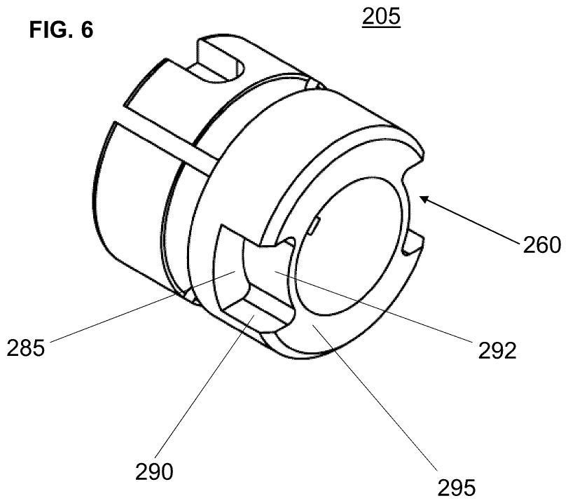

With reference to FIGS. 2, 4, 5 and 6 and according to an embodiment of the present disclosure, the teeth 255 of the setting tool 250 are inserted within the anchor recesses 260 of the anchor 205, the setting tool 250 being poised to push the anchor 205 in the direction of the arrows of FIG. 2, into the pre-drilled bore hole 245. As best shown in FIGS. 4 and 5, and according to one embodiment of the present disclosure, each of the teeth 255 comprise an upper surface 275, a pair of outer side walls 280 and a convex wall 282. Each of the anchor recesses 260 comprises an overhang 285, a pair of inner side walls 290 and a concave wall 292. A worker skilled in the art would appreciate that when the teeth 255 are positioned within the anchor recesses 260 as shown in FIG. 2, the upper surfaces 275 of the teeth 255 are flushly in contact with the overhangs 285 of the anchor 205. Meanwhile, the convex walls 282 cooperate and are flush with the concave walls 292. This flush cooperation increases the shear strength of the anchor 205 during setting. Additionally, it is understood that once the anchor 205 is set, the neck 230 of the bullet 210 is completely positioned within the lower end of the anchor 205, in between the two concave walls 292. Thusly, the anchor 205 is no longer hollow in this region between the two concave walls 292 when the anchor 205 is set, which serves to increase the shear strength of the anchor 205. It is also understood that when the upper surfaces 275 are flushly in contact with the overhangs 285, a base surface 270 positioned at the upper end of the setting tool 250 is in flush contact with an anchor contact surface 295 positioned at a lower end of the anchor 205. This flush contact is best shown in FIGS. 3 and 5, whereby the base surface 270 of the setting tool 250 flushly mates with the anchor contact surface of the anchor 205, and the upper surface 275 of the teeth 255 of the setting tool 250 flushly mates with the overhangs 285 of the recesses 260. When the anchor 205 is secured to the setting tool 250, the outer side walls 280 abut the inner side walls 290 to transfer any rotational movement from the setting tool 250 to the anchor 205. In the embodiment of FIG. 2, both the setting tool 250 and the anchor 205 have yet to be rotated and the cutter 215 has not yet cut or bore into material in the pre-drilled bore hole 245.

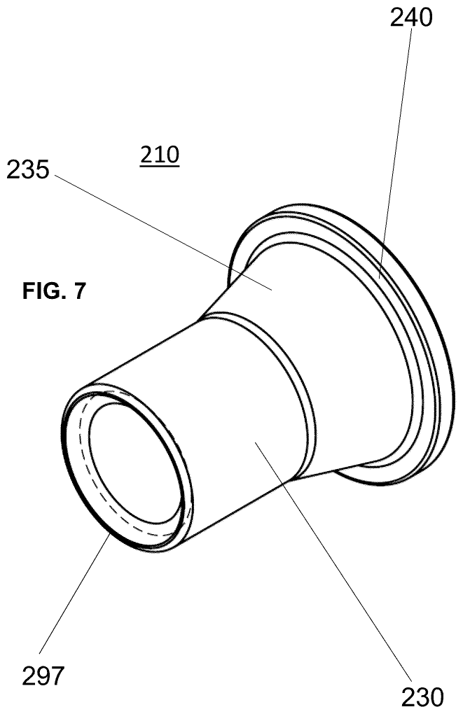

With reference to FIGS. 3, 4, 5, 6 and 7, and according to an embodiment of the present disclosure, the setting tool 250 is shown driving the anchor 205 upward into the pre-drilled bore hole 245. With particular reference to FIG. 3, as the anchor 205 is driven upward in the direction of the arrow by setting tool 250, the lamellae 225 spread radially over the body 235 of the bullet 210, thereby allowing the cutter 215 to cut and bore into material of the pre-drilled bore hole 245. In one embodiment of the present disclosure, an upper end of the cutter 215 comprises a tapered face 305 that avoids contact between the cutter 215 and both the body 235 and the radial flange 240 of the bullet 210 while the lamellae 225 are spreading radially. The radial expansion of the lamellae 225 is stopped when the upper ends of the lamellae 225 contact the radial flange 240. The lower end of the neck 230 comprises a bullet contact surface 297 that is in flush contact with the base surface 270 of the setting tool 250 when the upper ends of the lamellae 225 contact the radial flange 240. The setting tool 250 is then rotated, thereby urging the anchor 205 rotate, that in turn drives the cutter 215 to circumferentially cut material within the pre-drilled bore hole 245. Although the curved arrow in FIG. 3 indicates that the setting tool 250 is rotatable in one clockwise direction, a worker skilled in the art would understand that the setting tool may be rotated in an opposite direction as well.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. An expansion anchor system for use in a pre-drilled bore hole, the system comprising:
an anchor comprised of at least two spreading lamellae to expand in the bore hole; and,
a bullet to provide a surface on which the at least two spreading lamellae can spread to set the anchor, the bullet comprising a radial flange,
wherein the spreading of the at least two spreading lamellae is stopped by the radial flange.

2. The expansion anchor system of claim 1, wherein a lower end of the anchor comprises an anchor contact surface adapted to be in flush contact with a setting tool contact surface positioned at an upper end of a setting tool.

3. The expansion anchor system of claim 1, wherein the bullet is further comprised of:
a neck to be positioned in the anchor; and
a body extending from the neck, the body expanding radially and terminating in the radial flange,
wherein the radial flange has a first diameter that is greater than a second diameter of the body.

4. The expansion anchor system of claim 3, wherein a lower end of the neck comprises a bullet contact surface that is adapted to be in flush contact with a setting tool contact surface positioned at an upper end of a setting tool.

5. The expansion anchor system of claim 1 wherein the anchor is further comprised of at least one cutter, the at least one cutter positioned on one of the at least two spreading lamellae to cut through a material in the pre-drilled bore hole.

6. The expansion anchor system of claim 5, wherein an upper end of the at least one cutter comprises a tapered face to avoid contact between the at least one cutter and the bullet during setting of the anchor.

7. The expansion anchor system of claim 1, wherein upper ends of the at least two spreading lamellae abut against the radial flange of the bullet when the expansion anchor is set.

8. The expansion anchor system of claim 1, wherein the body of the bullet is trapezoid-shaped.

9. The expansion anchor system of claim 3, wherein the neck of the bullet is positioned in between two concave walls of the anchor once the anchor is set, to increase the shear strength of the anchor.

10. A bullet for use with an anchor to set in a pre-drilled bore hole, the bullet comprising:
a neck adapted to be positioned in the anchor; and,
a body extending from the neck, the body expanding radially and terminating in a radial flange,
wherein the radial flange has a first diameter that is greater than a second diameter of the body, the radial flange to provide a stop point for the anchor when the anchor is set.

11. The bullet of claim 10, wherein a lower end of the anchor comprises an anchor contact surface adapted to be in flush contact with a setting tool contact surface positioned at an upper end of a setting tool.

12. The expansion anchor system of claim 10, wherein the bullet is further comprised of:
a neck to be positioned in the anchor; and
a body extending from the neck, the body expanding radially and terminating in the radial flange,
wherein the radial flange has a first diameter that is greater than a second diameter of the body.

13. The expansion anchor system of claim 12, wherein a lower end of the neck comprises a bullet contact surface that is adapted to be in flush contact with a setting tool contact surface positioned at an upper end of a setting tool.

14. The expansion anchor system of claim 10 wherein the anchor is further comprised of at least one cutter, the at least one cutter positioned on one of at least two spreading lamellae to cut through a material in the pre-drilled bore hole.

15. The expansion anchor system of claim 14, wherein an upper end of the at least one cutter comprises a tapered face to avoid contact between the at least one cutter and the bullet during setting of the anchor.

16. The expansion anchor system of claim 14, wherein upper ends of the at least two spreading lamellae abut against the radial flange of the bullet when the expansion anchor is set.

17. The expansion anchor system of claim 10, wherein the body of the bullet is trapezoid-shaped.

18. The expansion anchor system of claim 12, wherein the neck of the bullet is positioned in between two concave walls of the anchor once the anchor is set, to increase the shear strength of the anchor.
